(19) United States
(12) Patent Application Publication
(10) Pub. No.: US 2010/0018087 A1
(43) Pub. Date: Jan. 28, 2010

(54) Conveyance Displays and Methods of Installation

(76) Inventors: Rod Erickson, Arvada, CO (US); Troy Van Wyke, Centennial, CO (US)

Correspondence Address: Leyendecker & Lemire, LLC, C/O PORTFOLIO IP, P.O. BOX 52050, MINNEAPOLIS, MN, 55402, US

(21) Appl. No.: 12/509,992

(22) Filed: Jul. 27, 2009

Related U.S. Application Data
(60) Provisional application No. 61/083,949, filed on Jul. 27, 2008.

(51) Int. Cl. G09F 19/22

(52) U.S. Cl. 40/1

(57) ABSTRACT

Conveyance displays comprising display films installed proximate conveyances such as elevators and escalators are described. The conveyance displays are adapted to presentation of vivid and complex images and text. Moreover, conveyance displays comprising display films are adapted to relatively fast installation, maintenance, and repair.

This application claims priority to, and incorporates by reference, U.S. provisional Patent Application Number 61083949, filed 27 Jul., 2008, titled “People Mover Displays and Methods of Use and Installation”, having the same inventors as the present application.

### FIELD OF THE INVENTION

The present invention relates generally to surface displays installed on visible surfaces of and proximate to conveyances such as elevators, escalators, moving sidewalks.

### BACKGROUND

Decor of most visible surfaces of conveyances such as elevators and escalators tends to be changed infrequently, owing in part to difficulty in changing appearances of areas in steady use and often in close proximity to the public. Accordingly, large advertising displays on such surfaces are relatively uncommon, at least in part because of the desirability of changing advertising displays relatively frequently. In addition, complex or dramatic graphical displays on such visible surfaces are also relatively scarce. Moreover, appearance of some of the visible surfaces of tends to degrade over time due to heavy use.

Covering visible surfaces of elevators with treatments such as paint, wall paper, and upholstery is a usual practice for creating a desirable appearance. Appearances on large swaths of such surfaces are often left unaltered for relatively long periods of time. Changing conveyance appearance can be expensive, time consuming, or intrudes on normal use of the conveyance or space in proximity to the surface being altered. Painting or other surface treatments that require substantial time to install, dry, or cure are especially ill suited to frequent installation proximate a conveyance. Such treatment may require taking the conveyance out of service for a substantial time interval.

### BRIEF DESCRIPTION OF THE DRAWINGS

FIG. 1 is a perspective view of a conveyance display according to one embodiment of the present invention.

FIG. 2A is a perspective view of a conveyance adapted to installation of a conveyance display according to one embodiment of the present invention.

FIG. 2B is a perspective view of a conveyance display according to one embodiment of the present invention.

FIG. 3 is a front, perspective view of a conveyance display according to one embodiment of the present invention

FIG. 4 is a perspective view of a conveyance display according to one embodiment of the present invention.

FIG. 5 is a front, perspective view of a conveyance display according to one embodiment of the present invention

FIG. 6 is a flow chart for a method of installing a conveyance display according to one embodiment of the present invention.

FIG. 7 is a block diagram of an exemplary computer system as can be utilized in methods of installing embodiments of the present invention.

### DETAILED DESCRIPTION

Embodiments of conveyance displays according to the present invention comprise display films installed proximate elevators or other conveyances, the display films covering, decorating, or adorning visible surfaces. The conveyance displays are typically adapted to be installed and changed relatively quickly and unobtrusively. Some embodiments of conveyance displays create complex, vivid, dramatic, or visually compelling designs or appearances. Some conveyance display surfaces may be adapted to be easily cleaned, repaired, or replaced.

Embodiments of the present invention comprise display film installed on visible surfaces of elevators or other conveyances. The display film is typically, but not necessarily, installed on vertical surfaces of doors, door jams, or walls. Examples include display film installed on surfaces of elevator doors, door jams, and walls, and displays on inside and outside surfaces of escalator balustrades. Examples of display film include, but are not limited to, vinyl film and other polymeric film products from 3M™, Hewlett-Packard, and InteliCoat Technologies®.

Embodiments of the present invention comprise display films adapted to be quickly installed on a suitable surface, and some display films and adhesives are adapted to ready realignment or adjustment during or after installation. Ideal surfaces for installing display film are typically clean, dry, and smooth, and are frequently, but not necessarily, relatively non-porous. Some surfaces are less than ideal because they are somewhat rough or porous, but may still be suitable for display film installation with an appropriate display film and adhesive. Such surfaces include, but are not limited to, corrugated and riveted surfaces, concrete block, brick, and stucco. Very porous surfaces such as fabric, and surfaces rougher than 150 grit sandpaper are typically poorly suited for display film installation.

### Terminology:

The terms and phrases as indicated in quotation marks (“”) in this section are intended to have the meaning ascribed to them in this Terminology section applied to them throughout this document, including in the claims, unless clearly indicated otherwise in context. Further, as applicable, the stated definitions are to apply, regardless of the word or phrase's case, tense or any singular or plural variations of the defined word or phrase.

The term “or” as used in this specification and the appended claims is not meant to be exclusive rather the term is inclusive meaning “either or both”.

References in the specification to “one embodiment”, “an embodiment”, “a preferred embodiment”, “an alternative embodiment”, “a variation”, “one variation”, and similar phrases mean that a particular feature, structure, or characteristic described in connection with the embodiment is included in at least an embodiment of the invention. The appearances of phrases like “in one embodiment”, “in an embodiment”, or “in a variation” in various places in the specification are not necessarily all meant to refer to the same embodiment or variation.

The term “couple”, “coupled”, “coupling”, or any variation thereof, as used in this specification and the appended claims refers to either an indirect or direct connection between the identified elements, components or objects. Often the manner of the coupling will be related specifically to the manner in which the two coupled elements interact. Specifically, this term may be used to define tow elements joined by a bolted fastener, a latch, a hook, or any other reasonably readily removable fastening device.

The term “integrate” or “integrated” as used in this specification and the appended claims refers to a blending, uniting, or incorporation of the identified elements, components or objects into a unified whole.

Directional and/or relationary terms such as, but not limited to, left, right, nadir, apex, top, bottom, vertical, horizontal, back, front and lateral are relative to each other and are dependent on the specific orientation of a applicable element or article, and are used accordingly to aid in the description of the various embodiments and are not necessarily intended to be construed as limiting.

As applicable, the terms “about” or “generally” as used herein unless otherwise indicated means a margin of ±20%. Also, as applicable, the term “substantially” as used herein unless otherwise indicated means a margin of ±10%. It is to be appreciated that not all uses of the above terms are quantifiable such that the referenced ranges can be applied.

The term “conveyance,” or “conveyances,” as used in this specification and appended claims, refers to elevators, escalators, moving sidewalks, and similar devices adapted to move people and freight. For the purposes of this application, conveyances includes freight elevators and dumbwaiters.

The term “proximate,” as used in this application and appended claims, means in, on, or immediately surrounding a conveyance. Accordingly, a display film installed proximate a conveyance is installed in, on, or immediately surrounding the conveyance. Examples of immediate surroundings of a conveyance include walls outside a hoistway and adjacent to hoistway doors, floors and ceilings immediately outside a hoistway door, and floors, ceilings, or walls surrounding and visible from an escalator or moving sidewalk.

The term “elevator” or “elevators,” as used in this specification and appended claims, refers to devices familiar to most persons, for moving people and freight vertically, and typically among floors of a building or structure. As used herein, an elevator typically comprises an elevator cab in which people or freight ride in order to be transported vertically. An elevator cab typically travels along a vertical axis in a hoistway, and comprises cab doors disposed at one or more cab portals. The hoistway typically comprises hoistway doors disposed at one or more hoistway portals.

The term “display film” or “display films,” as used in this specification and appended claims, refers to films comprising polymers such as, but not limited to, polyvinyl chloride (vinyl), polyethylene terephthalate (PET), polyolefins such as polyethylene (PE) or polypropylene (PP), polyetheretherketone (PEEK), polyimide, polycarbonate, polyaniline, acrylate or methacrylate polymers, or fluorinated polymers such as polytetrafluoroethylene or polyfluoroethylenepropylene. Display films comprising vinyl or PET are more common. Display films sometimes include removable backing paper. Variations of display films are adapted to use as media for printing technology or other image creation including, but not limited to, laser printing, inkjet printing, piezo inkjet printing, screening, and ink or dye sublimation. Variations of display films may be visibly opaque, translucent, or clear or transparent, and may also be reflective, transmissive, transflective, or polarized. Display film surfaces can be glossy, semi-glossy, or matte. Examples of commercially available display films include, but are not limited to: 3M™ products such as Scotchcal™ overlaminate and graphic film, Scotchlite™ reflective sheeting, Panagraphics™ flexible substrate, and Controltac™ graphic film; durable display films and display film paper from Hewlett-Packard®, and InteliCoat Technologies® display films. Display films are typically adapted to adhere to a display surface through means such as adhesive compositions, magnetism, or static charge. Display film differs from wallpapers, which comprise a woven (fabric) or non-woven (paper) substrate. Wallpapers include substrates coated with acrylic or vinyl, and substrates laminated to acrylic or vinyl sheets, the coatings or sheets being bound to and not readily removed from the substrates, although some wallpapers are adapted to being uninstalled from walls by peeling or tearing the laminated sheets from the substrate.

The term “display surface,” as used in this specification and appended claims, refers to a surface adapted to adherence by a display film, and that is visible to users of an elevator or other conveyance, or visible to people near the elevator or other conveyance. Examples of display surfaces include, but are not limited to, elevator cab inwardly facing surfaces such as wall interior surfaces, elevator cab door interior surfaces, elevator cab ceiling interior surfaces, elevator cab floor interior surfaces, and stand off panels or similar raised panels on elevator cab interior surfaces. Other display surfaces include visible hoistway surfaces such as hoistway wall exterior surfaces, hoistway door jams, and hoistway door exterior surfaces. Surfaces that face into the interior of a hoistway, such as hoistway wall interior surfaces and elevator cab exterior surfaces, may comprise display surfaces if the hoistway comprises transparent or translucent walls, thereby making a hoistway interior surface or elevator cab exterior surface visible during normal operation of the elevator. Windows or transparent/translucent walls or doors of an elevator cab or hoistway can provide display surfaces on which display films can be installed to interesting effect, with light traveling through the transparent/translucent component to illuminate the display film installed thereon.

The term “display area,” as used in this specification and appended claims, refers to an area slated for installation of a display film. According to this definition, the size and shape of a display film is the same as the size and shape of a display area where the display film is to be installed.

### A First Embodiment Conveyance Display

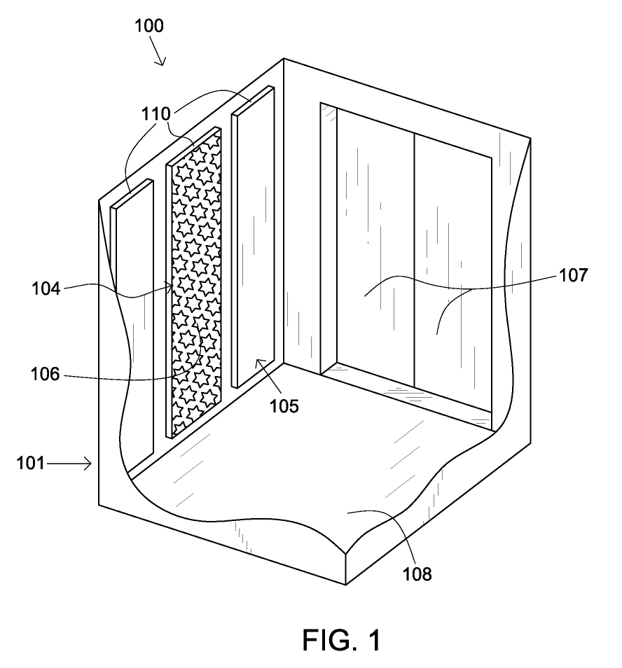

A first embodiment conveyance display 100 is illustrated in FIG. 1. The first embodiment conveyance display comprises numerous display surfaces inside an elevator cab 101, including a first display surface 104, the first display surface being an inwardly facing planar surface of a standoff panel 110. Disposed on the first display surface is a first display film 106. The first display film comprises a graphic design displayed on 3M™ Controltac™ Graphic Film with Comply™ Adhesive 180C. The first display film is adapted to be relatively easily removed, whereupon it may be replaced by another display film, or reinstalled. The first display film is thus adapted to ready adjustment or replacement. Other embodiments comprise other display films and adhesives or other means for affixing the display films to display surfaces.

The first display surface comprises stainless steel. Because it is relatively smooth, non-porous, and easy to clean, the stainless steel is a highly suitable surface for the first display film 106 to adhere to. Other embodiments comprise smooth, non-porous surfaces such as, but not limited to, metal, metal alloy, painted surfaces, plastic, and glass, that are also highly suitable for installing display film. Slightly rough or porous surfaces may be suitable as well. Variations of display films comprise magnetic material adapted to adhere through magnetic attraction to ferromagnetic surfaces, and some display films employ static charge mediated attraction to adhere to display surfaces.

Other embodiments of the present invention comprise display films including, but not limited to, examples listed in Table I.

TABLE I

| TYPE OF DISPLAY FILM | EXAMPLE |
|---|---|
| Wall Wraps Vinyl | 3M ™ Scotchcal ™ Graphic Film for Textured Surfaces - IJ8624 |
| Perforated Window Film | 3M ™ Scotchcal ™ Perforate Window Graphic Film - IJ8171 |
| | 3M ™ Scotchcal ™ Optically Clear Overlaminate - 8914 |
| Perforated Window Film | 3M ™ 8914ES Window Film Overlaminate |
| Overlaminates | |
| Special Effects Wrap Vinyls | Vinyl efx Outdoor Durable TMP Gold or Silver Vinyl |
| Solvent Removable Vinyl | 3M ™ Controltac ™ Graphic Film with Comply ™ Adhesive |
| | 3M ™ Scotchcal ™ Changeable Graphic Film-IJ3555 |
| Permanent Solvent Printable Vinyl | 3M ™ Scotchcal ™ Graphic Film IJ35-10 Vinyl |
| Standard Vinyl Overlaminates | 3M ™ Scotchcal ™ Luster Overlaminate-8519 |
| Floor Vinyl & Specialty Overlaminates | 3M ™ Scotchcal ™ High Gloss Overlaminate 3648 |
| Optically Clear Overlaminates | 3M ™ Scotchcal ™ Optically Clear Overlaminate 8914 |
| Protection Films | 3M ™ 8513 Protective Film or similar material |
| Computer Cut Vinyl | 3M ™ Scotchcal ™ General Purpose Graphic Film Series 50 |
| | 3M ™ Scotchcal ™ Graphic Film Series 7125 |
| | 3M ™ Controltac ™ Graphic Film with Comply ™ Adhesive |
| Reflective Vinyls | 3M ™ Scotchlite ™ Engineer Grade Reflective Sheeting |
| Translucent Vinyl | 3M ™ Panagraphics ™ III Wide Flexible Substrate |
| Railroad, Marine & Solid Color | 3M ™ Scotchcal ™ Graphic Film Series 8000 |
| Wrapping | |
| Etched Glass Window Vinyl | 3M ™ Scotchcal ™ ElectroCut ™ Graphic Film Series 7725SE |
| Static Cling, Clear & Removable Vinyl | Avery Graphics ™ Static Cling Vinyl Film |
| Metallic Vinyl | 3M ™ Controltac ™ Graphic Film with Comply ™ Adhesive |
| Economy Gold & Silver Vinyl | Avery Dennison Graphics Specialty pressure-sensitive vinyl |
| | films - A5863 Gold Leaf and A5864 Silver Leaf |
| High Performance Gold & Silver | Vinyl efx outdoor Durable TMP Heavy Metal vinyl Film |
| Vinyl | |
| Diamond Plate & Holographic Vinyl | Vinyl efx Special Effects Vinyl |
| Special Effects Vinyl | Vinyl efx Special Effects Vinyl |
| Fluorescent & Glow-in-the-dark Vinyl | Vinyl efx TMP Silver Carbon Fiber |
| Magnetic Vinyl | DigiMag ® VINYL Magnetic Sheeting |

The first embodiment elevator cab 101 comprises a second display surface 105, the second display surface also being and an inwardly facing planar surface of a raised panel 110. The second display surface is without a display film, but is adapted to ready installation of a display film. A second display film (not shown) could thus be installed on the second display surface in a few minutes, requiring a relatively short downtime interval for the elevator. Similarly, the first display film 106 is adapted to be readily removed from the first display surface, and a replacement display film could be quickly installed in place of the first display film on the first display surface. Consequently, relatively major changes in appearance of the elevator cab can be achieved with a relatively short downtime interval for the elevator cab.

Third display surfaces 107 comprise inside surfaces of elevator cab doors. The third display surfaces are without display films. In some embodiments, a floor of an elevator can comprise a display surface. It is recognized that a display film disposed on an elevator floor is subject to increased wear and damage due to elevator users walking on the floor display film. Accordingly, it would likely be desirable to protect a floor display film with a clear protective laminate or other relatively transparent protective layer. In some embodiments, an elevator ceiling provides a display surface, and display films are disposed thereupon.

### A Second Embodiment Conveyance Display

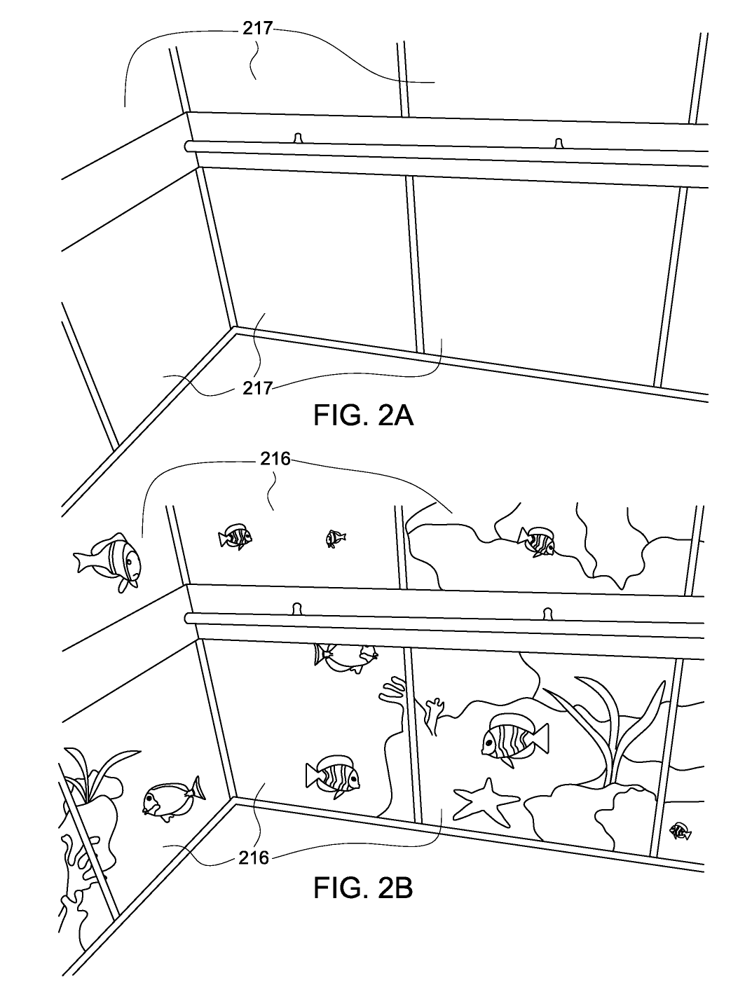

A second embodiment conveyance display, which is installed inside an elevator cab, is illustrated in FIG. 2B. The second embodiment conveyance display comprises fourth display films 216 installed on fourth display surfaces 217, the fourth display surfaces being illustrated in FIG. 2A without display films installed thereupon. The fourth display films collectively depict an underwater panorama, each of the individual fourth display films complementing adjacent fourth display films to create a scene that appears relatively continuous.

The fourth display surfaces 217 are inwardly facing surfaces of walls of the elevator cab. In this second embodiment, the elevator cab walls comprise relatively transparent glass panels, and a hoistway enclosure (not shown) outside the elevator cab also comprises relatively transparent glass panels. Thus light from outside the hoistway shines through the clear glass panels of both the hoistway and cab to illuminate the fourth embodiment display films 216, creating an interesting visual effect for users inside the elevator cab. Similarly, light from inside the elevator cab shines through the glass panels to illuminate the second embodiment display films 216 for observers outside the elevator who can see through the clear walls of the hoistway.

### A Third Embodiment Conveyance Display

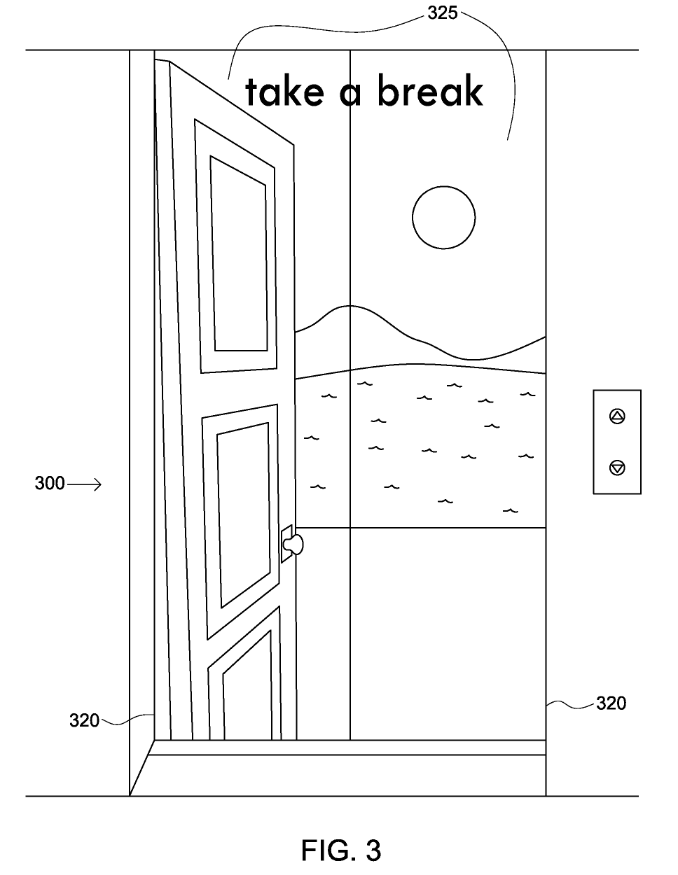

A third embodiment conveyance display 300 is illustrated in FIG. 3. The third embodiment conveyance display comprises elevator hoistway doors 320, the hoistway doors comprising fifth display surfaces, which are exterior surfaces of the hoistway doors. Disposed on the fifth display surfaces are two fifth display films 325.

When the hoistway doors 320 are closed, as illustrated in FIG. 3, the fifth display films create an appearance of a swinging door opening onto a beach. This appearance is unusual for hoistway doors, and some observers might find the appearance appealing. The appearance may be controversial however. Thus it might be desirable to remove or replace the third embodiment conveyance display. Use of display film makes both installation and removal of the third embodiment conveyance display rapid and facile. Accordingly, installing an unconventional, and possibly controversial, display, such as the third embodiment conveyance display, becomes less risky and more feasible because it can be changed or removed with minimal effort or inconvenience.

### A Fourth Embodiment Conveyance Display

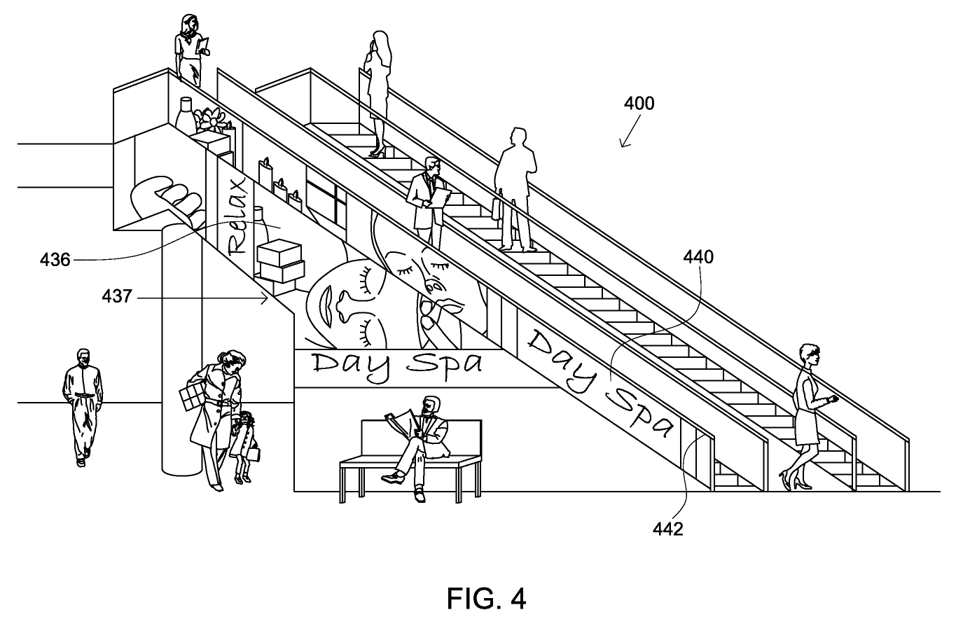

A fourth embodiment conveyance display 400 is illustrated in FIG. 4. The fourth embodiment conveyance display comprises a sixth display film 436 disposed on a sixth display surface, the sixth display surface being an outwardly facing surface of an escalator side wall 437. The sixth display film comprises an advertisement for a day spa. The fourth embodiment conveyance display further comprises a seventh display film 440 installed on an escalator balustrade 442.

Other embodiments of conveyance displays comprise display films disposed on escalator bottom pans or other visible surfaces proximate escalators. Still other embodiments comprise display films disposed on balustrades, sidewalls, or visible surfaces proximate moving sidewalks.

### A Fifth Embodiment Conveyance Display

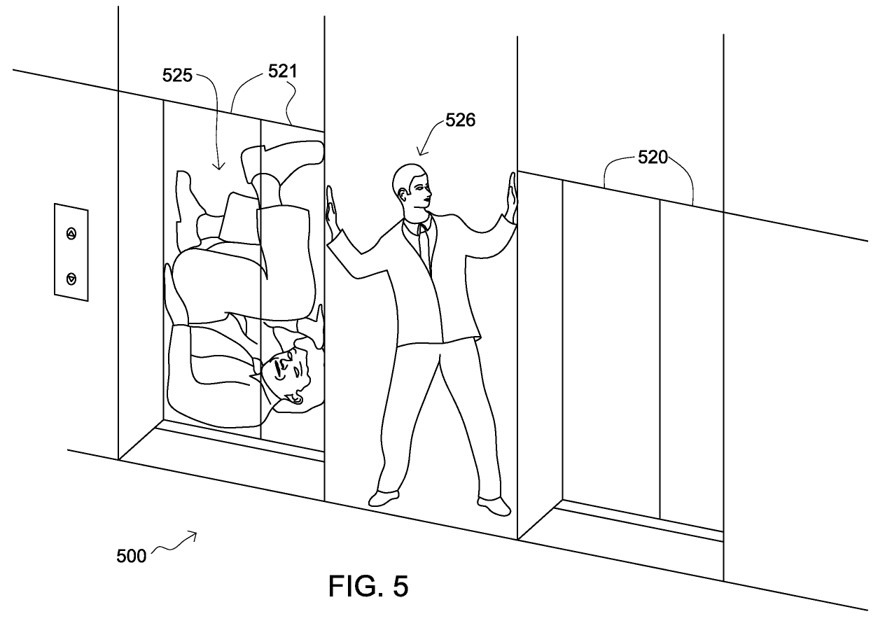

A fifth embodiment conveyance display 500 is illustrated in FIG. 5. The fifth embodiment conveyance display comprises first hoistway doors 520 and second hoistway doors 521. A display film 525 depicting a crouched, upside down man resides on the second hoistway doors.

In between the first hoistway doors 520 and the second hoistway doors 521, disposed on a wall adjacent to the first and second hoistway doors, resides another display film 526 depicting a standing man.

### A Method of Installing a Conveyance Display

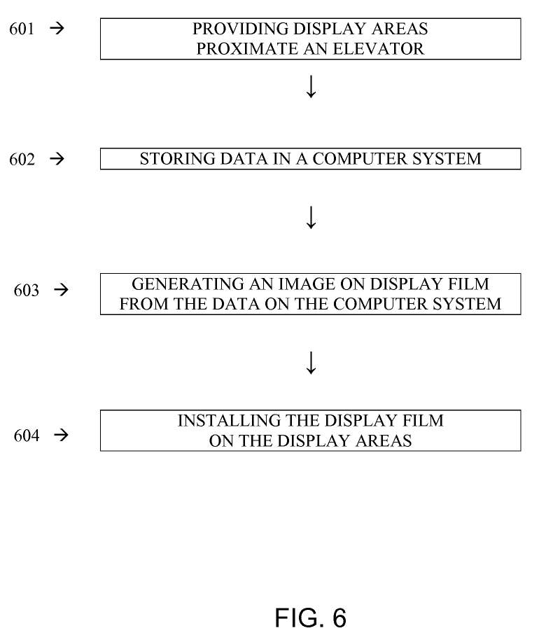

A method of installing a conveyance display is illustrated by a flow chart in FIG. 6. A first operation 601 of the method of installing a conveyance display comprises providing display areas proximate an elevator. The display areas comprise display surfaces disposed on elevator cab inside walls, elevator cab door inside surfaces, hoistway door jams, hoistway door outside surfaces, and walls adjacent to the hoistway door outside surfaces.

A second operation 602 of the method of installing a conveyance display comprises storing data in a computer system. The data is put into the computer system by scanning a photograph and importing data created by the scanning. In other embodiments, data is put into a computer system by any of various data input means, including, but not limited to, scanning, importing from a digital camera, importing from data storage media such as memory sticks, compact discs, DVDs, or importing from the internet or other network. In some embodiments, the data is generated within the computer by a program. Storing the data includes transient storage, such as in random access memory or other energy dependant memory, or more persistent storage such as on a hard drive.

A third operation 603 of the method of installing a conveyance display comprises using the data stored in the computer system to produce a visual image on display film. The visual image is printed on the display film by piezo inkjet printing based on the data and commands from the computer system. The display film is 3M™ Controltac™ Changeable Graphic Vinyl film. In other embodiments, the visual image is produced on other display films by other image generation techniques such as, but not limited to, screening, sublimation, or laser printing.

A fourth operation 604 of the method of installing a conveyance display comprises installing the display film on the display areas proximate the elevator using 3M™ Comply™ adhesive.

### An Exemplary Computer System for Installing a Conveyance Display

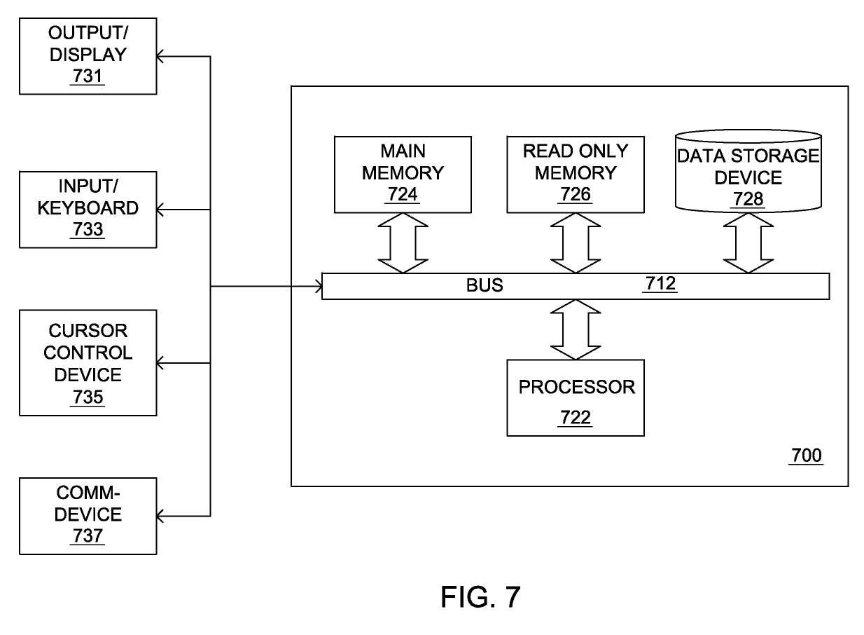

FIG. 7 illustrates an exemplary general purpose computer system upon which methods of installing embodiments of a conveyance display can be implemented. The computer system 700 comprises a bus or other communications means 712 for communicating data or information, and a processing means such as a processor 722. The computer system 700 further comprises a random access memory (RAM) or other similar dynamically-generated data storage device 724 (referred to as main memory in FIG. 7 and hereinafter). The main memory 724 is coupled to the bus 712 for storing information and instructions to be executed by the processor 722. Additionally, the main memory 724 can be used for storing temporary variables or other intermediate information during execution of instructions by the processor 722. The computer system 700 also comprises a read only memory (ROM) and/or other static storage device 726 coupled to the bus 712 for storing static information and instructions for the processor 722.

A data storage device 728 such as, but not limited to, a solid state drive or an optical disk drive can also be coupled to the bus 712 as a component of the computer system 700 for storing data and instructions. The computer system 700 can also be coupled via the bus 712 to an output or display device 731, such as but not limited to a cathode ray tube (CRT) on liquid crystal display (LCD) for displaying information to a user. Typically, an input device such as an alphanumeric keyboard 733, including alphanumeric, symbol, and other keys can be coupled to the bus 712 for communicating information and/or command selections to the processor 722. Another type of user input device is a cursor control device 735, such as a mouse, trackball, or cursor direction keys for communicating information and/or command selections to the processor 722 and for controlling cursor movement on the display 731.

The computer system 700 can also include a communications device or interface 737. Communications device 737 can be coupled to the bus 712 and allows data and software to be transferred between the computer system 700 and external networks and devices. Examples of communications device 737 include a modem, a network interface card, a wireless network interface card, or other well-known interface device, such as those used for Ethernet, token ring, asynchronous transfer mode (ATM), or other types of physical attachment for purposes of providing a communications link to support a local or wide area network. In this manner, the computer system 700 can be coupled to a number of clients and/or servers via a conventional network infrastructure, such as and intranet and/or the Internet, for example. It is appreciated that a lesser or more equipped computer system than the example described above can be desirable for certain implementations of methods of installing embodiments of the conveyance display. Therefore, the configuration of the computer system 700 may vary from implementation to implementation depending on numerous factors. It is pertinent to note that, while the operations and commands required for installing embodiments of the conveyance display can be performed under the control of a programmed processor, such as the processer 722 in FIG. 7, in alternative embodiments, the operations and commands can be fully or partially implemented by any programmable or hard-coded logic, such as but not limited to field programmable gate arrays (FPGAs), TTL logic, application specific integrated circuits (ASICs), for example. Additionally, the methods of installing embodiments of the conveyance display can be performed by any combination of programmed general purpose computer components and/or custom hardware components.

Methods of installing embodiments of the conveyance display can be implemented as a sequence of computer-implemented steps running on the computer system or as interconnected modules within the computer system. Moreover, methods of installing embodiments of the conveyance display can be implemented on a special purpose computer, a general purpose computer programmed to execute the required operations and commands.

### Other Embodiments and Variations

The various embodiments and variations thereof, illustrated in the accompanying Figures and/or described above, are merely exemplary and are not meant to limit the scope of the invention. It is to be appreciated that numerous other variations of the invention have been contemplated, as would be obvious to one of ordinary skill in the art, given the benefit of this disclosure. All variations of the invention that read upon appended claims are intended and contemplated to be within the scope of the invention.

I claim:

1. A conveyance display comprising a display film installed on a display surface proximate a conveyance.

2. The conveyance display of claim 1, wherein the conveyance is an elevator, the elevator comprising an elevator cab and a hoistway.

3. The conveyance display of claim 2, wherein the display surface is disposed on the elevator cab.

4. The conveyance display of claim 3, wherein the elevator cab comprises an elevator cab door and the display surface is disposed on the elevator cab door.

5. The conveyance display of claim 2, wherein the elevator further comprises a raised panel and the display surface disposed on the raised panel.

6. The conveyance display of claim 2, wherein the display surface is disposed on the hoistway.

7. The conveyance display of claim 2, wherein the hoistway comprises a hoistway door and the display surface is disposed on the hoistway door.

8. The conveyance display of claim 7, further comprising a wall, the wall being outside the hoistway and adjacent to the hoistway door, and wherein the display surface is disposed on the wall outside the hoistway and adjacent to the hoistway door.

9. The conveyance display of claim 2, wherein the display surface is disposed inside the hoistway.

10. The conveyance display of claim 1, wherein the display surface comprises a substantially transparent or translucent wall or window.

11. The conveyance display of claim 1, wherein the conveyance comprises an escalator.

12. The conveyance display of claim 1, wherein the conveyance comprises a balustrade.

13. The conveyance display of claim 12, wherein the display film resides on a vertical surface of the balustrade.

14. A method of installing a conveyance display comprising:
providing the conveyance of claim 1;
providing a display area proximate the conveyance of claim 1;
providing a display film adapted to fit the display area; and
installing the display film on the display area.

15. The method of installing a conveyance display of claim 14, further comprising:
storing data in a computer system;
using the computer system and the data to create an image on the display film.

16. A method of installing a conveyance display comprising:
providing a display area proximate a conveyance;
providing a display film; and
installing the display film on the display area.

17. The method of installing the conveyance display of claim 16, further comprising:
storing data in a computer system;
using the computer system and the data to create an image on the display film.

18. The method of installing the conveyance display of claim 16, further comprising:
stopping operation of the conveyance prior to installing the display film; and
commencing operation of the conveyance after installing the display film, a time interval between stopping operation of the conveyance and commencing operation of the conveyance being less than 4 hours.

19. A conveyance display comprising:
a display film installed on a display surface proximate a conveyance, the display surface comprising a structure selected from a list consisting of a hoistway door, an elevator cab door, an elevator cab interior wall, a balustrade, and a wall adjacent to a hoistway door outside a hoistway.

20. A method of installing the conveyance display of claim 19 comprising:
storing data in a computer system;
using the computer system and the data to create an image on the display film; and
installing the display film on the display surface.
